(19) United States
(12) Patent Application Publication
(10) Pub. No.: US 2026/0222226 A1
(43) Pub. Date: Jul. 30, 2026

(54) Methods for signing data and providing signed data, and associated terminal and server

(71) Applicant: ORANGE, ISSY-LES-MOULINEAUX (FR)

(72) Inventors: Jean-Philippe WARY, CHATILLON CEDEX (FR); Antoine DUMANOIS, CHATILLON CEDEX (FR); Rémi NEDELEC, CHATILLON CEDEX (FR)

(21) Appl. No.: 19/146,056

(22) PCT Filed: Dec. 21, 2023
(86) PCT No.: PCT/EP2023/087477

§ 371 Date: Jul. 7, 2025

(30) Foreign Application Priority Data
Jan. 17, 2023 (FR) FR2300436

(51) Int. Cl. H04L 9/32

(52) U.S. Cl. CPC H04L 9/3247

(57) ABSTRACT

A data signature method implemented by a server. The method includes: receiving a signature request for at least one data sent by a terminal via a network; obtaining, by a secure element of the server, a signature of the at least one data by using a private key associated with the terminal, the signature being intended to be verified by a third party knowing a public key associated with the private key; obtaining a re-authentication key for the terminal from the network; encrypting the signature with an encryption function shared with the terminal and by using a transport key calculated from the re-authentication key and at least one other authentication key for the terminal or for a user of the terminal; and sending the encrypted signature to the terminal.

### PRIOR ART

The present invention relates to the field of data provision in a telecommunications network, and more specifically to the field of signed data provision.

Today, a very large number of electronic transactions are made by using a mobile terminal, and these transactions must be secure.

For example, the European Union has established an eIDAS (Electronic IDentification Authentication and trust Services) regulation on the electronic identification and the trust services for the electronic transactions.

Some provisions of this regulation for example impose a level of security that can only be obtained with mobile terminals including certified hardware security elements, for example a certified SIM (Subscriber Identity Module) card or TEE (Trusted Execution Environment) card to a level resistant to a level evaluation system AVA_VAN.5 as defined by “Common Criteria for Information Technology Security Evaluation-Part 3: Security assurance components” (CCMB-2017-04-003).

Unfortunately, most of the deployed mobile terminals do not currently include such components.

One solution proposed, for example, to provide personal identification data with such a high level of security, is to use external secure elements, such as a government ID card with a biometric module and an NFC (Near Field Communication) chip, and to place this card on the back of the mobile terminal to make a transaction.

It was determined that this solution was unsatisfactory for the users.

### OBJECT AND SUMMARY OF THE INVENTION

According to a first aspect, the invention relates to a data signature method implemented by a server and including steps of:
receiving a signature request for at least one data sent by a terminal via a network;
obtaining, by a secure element of the server, a signature of said at least one data by using a private key associated with the terminal, said signature being intended to be verified by a third party knowing a public key associated with said private key;
obtaining a re-authentication key for the terminal from the network;
encrypting the signature with an encryption function shared with the terminal and by using a transport key calculated from the re-authentication key and at least one other authentication key for the terminal or for a user of the terminal; and
sending the encrypted signature to the terminal.

Correlatively, the invention relates to a data signature server including:
a module for receiving a signature request for at least one data sent by a terminal via a network;
a secure element configured to obtain a signature of said at least one data by using a private key associated with the terminal;
a module for obtaining a re-authentication key for the terminal from the network;
a module for encrypting the signature with an encryption function shared with the terminal and by using a transport key calculated from the re-authentication key and at least one other authentication key for the terminal or for a user of the terminal; and
a module for sending the encrypted signature to the terminal.

According to a second aspect, the invention relates to a signed data provision method implemented by a terminal and including steps of:
sending a signature request for at least one data to a server via a network;
obtaining a re-authentication key for the terminal from the network;
receiving an encrypted signature;
decrypting the encrypted signature with an encryption function shared with the server and by using a transport key calculated from the re-authentication key and at least one other authentication key for the terminal or for a user of the terminal to obtain a signature of said data calculated by using a private key associated with the terminal; and
sending the signature to a third party configured to verify the validity of the signature with a public key associated with said private key, this third party possibly being a service provider requesting said signed data.

Correlatively, the invention relates to a terminal including:
a module for sending a signature request for at least one data to a server via a network;
a module for obtaining a re-authentication key for the terminal from the network;
a module for receiving an encrypted signature;
a module for decrypting the encrypted signature with an encryption function shared with the terminal and by using a transport key calculated from the re-authentication key and at least one other authentication key for the terminal or for a user of the terminal to obtain a signature of said data calculated by using a private key associated with the terminal; and
a module for sending the signature to a third party configured to verify the validity of the signature with a public key associated with said private key.

The invention also relates to a signed data provision system including at least one terminal and at least one server as mentioned above.

Thus, and generally, the invention proposes a solution in which data intended to be transmitted to a third party by a terminal as part of a transaction are previously signed by a server equipped with a secure element compliant with the security level required for this transaction.

In one particular embodiment, this secure element is an HSM (Hardware Security Module) component, namely an electronic module providing a security service consisting in particular of generating, storing and protecting cryptographic keys. This component may be a PCI (Peripheral Component Interconnect) plug-in electronic card on a computer or an external SCSI/IP (Small Computer System Interface/Internet Protocol) enclosure, for example.

In one particular embodiment of the invention, the HSM component complies with the AVA.VAN5 security level for the protection of the user's signature keys.

In accordance with the invention, the signature obtained by this secure element is encrypted by an entanglement of several keys, including at least one re-authentication key for the terminal from the network.

In one embodiment of the signature method or of the provision method, the re-authentication key used is the current key and the server does not specifically trigger re-authentication of the terminal to force the regeneration of the key.

In one embodiment, the server forces re-authentication of the terminal to regenerate the re-authentication key just before calculating the signature.

In one embodiment, the server forces re-authentication of the terminal to regenerate the re-authentication key after a relatively short delay, for example thirty seconds after sending the signature.

In one embodiment of the signature method or of the provision method, the re-authentication key is obtained by a method for re-authenticating a SIM card of the terminal from the home mobile network and triggered by said server.

This embodiment also ensures that only the user and the terminal coupled with this SIM card will be able to access the signed data to share it with the third party.

In one embodiment, the server triggers a re-authentication of the terminal from the network to regenerate the re-authentication key after sending the encrypted signature to the terminal, for example thirty seconds after this sending.

In one particular embodiment, this re-authentication method is an EAP-AKA (Extensible Authentication Protocol-Authentication and Key Agreement) type method.

This embodiment is particularly advantageous because the EAP-AKA mechanism ensures that the re-authentication key (C_{K}, I_{K}) known per se to those skilled in the art, then shared by the terminal and the server, has been regenerated substantially at the time of signature (just before or just after) and that it will only be valid for a short period. The server can even possibly re-trigger a new re-authentication of the terminal from the network, giving it a predetermined time to complete its transaction, for example one minute, so as to overwrite the re-authentication key used by the server to encrypt the signature and by the terminal to decrypt the signature.

In any case, it is recalled that the mobile network configuration rules established by the GSMA as part of the inter-operator roaming agreements require systematic customer re-authentication at least every ten network events (cell change, call reception, call origination, new data connection, radio zone change, re-attachment to the network after a radio cutoff, SMS/MMS message reception/transmission, etc.).

Thus, hacking the solution proposed by the invention is only possible during a relatively short or even very short lifetime of this re-authentication key after the transaction has been completed.

As a reminder, during a HIGH level security evaluation, in accordance with the European eiDAS regulations, the evaluation laboratories have three months to carry out attacks; the invention makes the attack system more complicated because it must be carried out in practice no later than a few minutes following the transaction.

In one embodiment of the signature method or of the provision method, the signature includes:
a timestamp data of an instant of calculation of said signature;
a hash of a concatenation of the data to be signed and of said timestamp data; and
a data obtained by encrypting said hash with another encryption function by using said private key, a function used to calculate said hash and the other encryption function being shared between said server and said third party.

This other encryption function for example implements an RSA (Rivest-Shamir-Adleman) type mechanism.

In this embodiment described here, the use of a timestamp data (and/or possibly of another anti-replay mechanism) provides an additional level of security since it allows the third party to verify the instant at which the signature they receive was calculated by the server. If the third party receives the signature too late compared to this calculation instant, they can then reject the transaction. This mechanism called anti-replay mechanism is known to those skilled in the art and can be achieved with several other techniques, such as for example replacing or supplementing this timestamp with a transaction serial number, coupled or not to a random data.

In one embodiment of the signature method or of the provision method, the transport key is calculated from a key calculated by using a derivation function shared between the terminal and the server and a personal service code of a user of the terminal.

This embodiment further ensures that only the user of the terminal can access the signed data to share it with the third party.

In one embodiment of the signature method or of the provision method, the transport key is calculated from a key calculated by using a derivation function shared between the terminal and the server and a key from an application of a secure electronic wallet of the terminal.

The calculation and the composition of the plurality of these different session keys (re-authentication key, personal service code, application key) ensures that these three elements are present at the user terminal and that the latter is able to reconstruct the transport key. This interweaving of possession (SIM card, electronic wallet application) and knowledge (service code) factors, combined with the lifespan of the ephemeral elements (re-authentication key, timestamp data), drastically reduces the attack surface of the proposed solution.

This embodiment further ensures that only the user and the terminal using this determined electronic wallet application will be able to access the signed data to share it with the third party.

At least one of these keys can be replaced or supplemented by another key accessible either by the terminal or by the user of the terminal, from the moment this new key, or a diversification of this key, is known to the server.

In one particular embodiment, the various steps of the data signature method or of the signed data provision method are determined by computer program instructions or are implemented by a silicon chip that comprises transistors adapted to constitute logic gates of non-programmable hard-wired logic.

Consequently, the invention also relates to a computer program on an information medium, this program being capable of being implemented in a controller computer, this program including instructions adapted to implement the steps of a data signature method or of a signed data provision method as described above.

This program may use any programming language and be in the form of source code, object code or intermediate code between source code and object code, such as in a partially compiled form or in any other desirable form.

The invention also relates to a computer-readable information medium including instructions for a computer program as mentioned above. The information medium may be any entity or device capable of storing the program. For example, the medium may include a storage means such as a ROM, a non-volatile flash memory, or a magnetic recording means for example a hard disk. On the other hand, the information medium may be a transmissible medium such as an electrical or optical signal which may be conveyed via an electrical or optical cable, by radio or by other means. The program according to the invention may be particularly downloaded over an Internet-type network. Alternatively, the information medium may be an integrated circuit in which the program is incorporated, the circuit being adapted to execute or to be used in the execution of the method in question.

One of the advantages of the invention is that the use of a server connected to the user's home mobile network allows said server to benefit from all the behavioral analysis and anti-fraud services of said mobile operators.

### BRIEF DESCRIPTION OF THE DRAWINGS

Other characteristics and advantages of the present invention will emerge from the description given below, with reference to the appended drawings which illustrate exemplary embodiments thereof without any limitation. In the figures:

FIG. 1 schematically represents a signed data provision system in accordance with one particular embodiment of the invention;

FIG. 2 illustrates one example of a schematic representation of a terminal in accordance with one particular embodiment of the invention;

FIG. 3 illustrates one example of a schematic representation of a server in accordance with one particular embodiment of the invention;

FIG. 4 illustrates one example of a phase of enrolling a user from a digital identity provider;

FIG. 5 illustrates one example of a phase of enrolling an application of the terminal of the figure from the server of FIG. 3;

FIG. 6 represents in flowchart form the main steps of a signed data provision method and of a data signature method in accordance with one particular embodiment of the invention;

FIG. 7 represents the hardware architecture of a terminal in accordance with one particular embodiment of the invention;

FIG. 8 represents the hardware architecture of a server in accordance with one particular embodiment of the invention.

### DESCRIPTION OF THE EMBODIMENTS

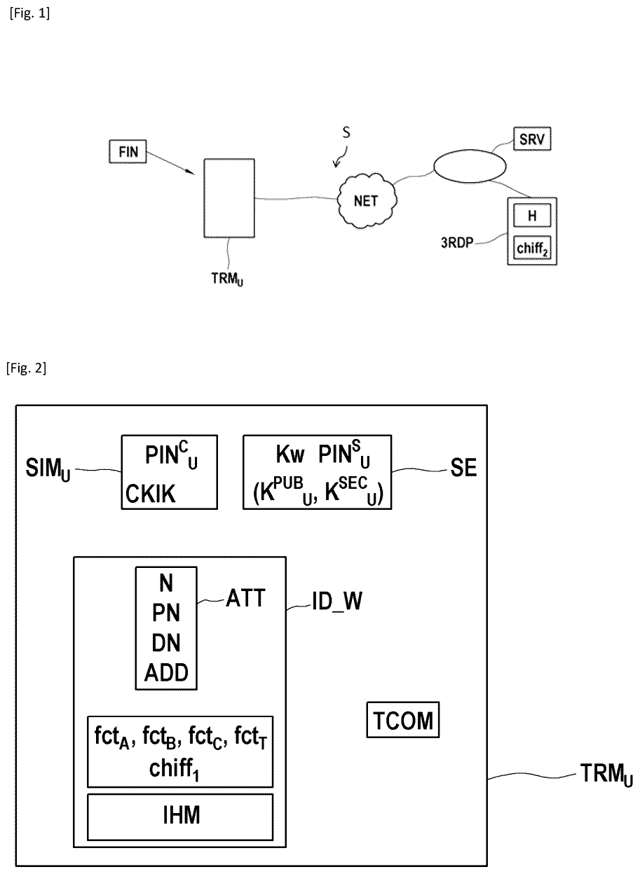

FIG. 1 schematically represents a signed data provision system in accordance with one particular embodiment of the invention.

This system allows a user U to send, by using their terminal TRM_{U}, signed data to a third party 3RDP. These data are for example personal data provided by a digital identity provider FIN. In this example, the terminal TRM_{U} is a mobile terminal TRM_{U} attached to a mobile network via a home network NET.

FIG. 2 schematically represents the terminal TRM_{U} of a user U in one embodiment of the invention.

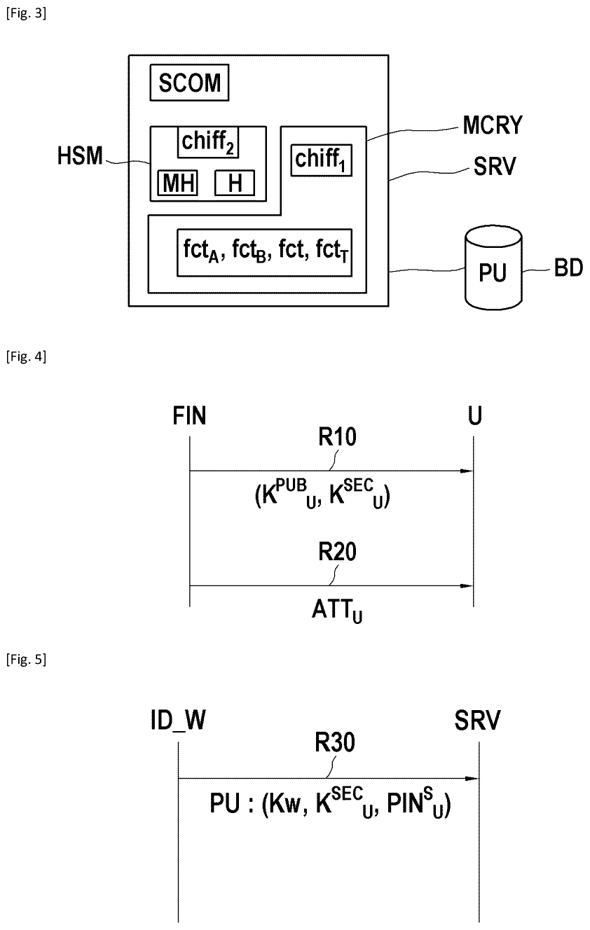

FIG. 3 schematically represents the server SRV in one embodiment of the invention.

The terminal TRM_{U} of the user includes a communication module TCOM on the mobile network and a SIM card SIM_{U}. The user U can authenticate themselves with the card SIM_{U} by using as is known a PIN (Personal Identification Number) code PIN^{C}_{U}.

The server SRV includes a communication module SCOM and a secure element constituted here by an HSM component.

In the embodiment described here, the terminal TRM_{U} includes a secure element SE. A secure element is a separate chip that contains a secure processor, a tamperproof storage and an execution memory. This processor, different from the host processor of the terminal TRM_{U}, allows making signed transactions.

In the embodiment described here, the terminal TRM_{U} includes a secure electronic wallet application ID_W associated with an application key K_{W}. This key K_{W} may for example be stored in a register of the application ID_W or in the secure element SE of the mobile terminal TRM_{U}.

In the embodiment described here, the server SRV includes a cryptographic module MCRY including a first encryption function chiff₁ and four key derivation functions fct_{A}, fct_{B}, fct_{C} and fct_{T} hereinafter referred to as first, second, third and fourth key derivation functions, respectively. These functions are shared with the application ID_W.

In the embodiment described here, the HSM component includes a timestamp module MH, a hash function H and a second encryption function chiff₂.

In the embodiment described here, the hash function H and the second encryption function chiff₂ are shared with the third-party 3RDP.

In the embodiment described, the signed data provision method includes a first enrollment phase to enroll the user U from a digital entity provider FIN.

This first enrollment phase is illustrated in FIG. 4 in one particular embodiment of the invention. In this embodiment, the digital entity provider FIN produces and provides (step R10) to the user U a pair consisting of a public key K^{PUB}_{U} and an associated private key K^{SEC}_{U}. This pair of keys can be used in asymmetric cryptography mechanisms known to those skilled in the art implementing for example RSA and elliptic curve algorithms.

In the embodiment described here, this pair of keys is stored in the secure element SE of the terminal TRM_{U}. As a variant, it can be stored in a memory register of the application ID_W.

In the embodiment described here, it is assumed that the digital identity provider FIN provides the user (step R20) with data that may be shared by the user with at least one third party 3RDP. In the exemplary embodiment described here, these data are attributes ATT_{U} related to the identity of the user U, for example their last name N, their first name PN, their date of birth DN and their address ADD and are recorded in memory registers of the application ID_W as illustrated in FIG. 2.

FIG. 5 illustrates a second enrollment phase making it possible to enroll the application ID_W from the server SRV in one particular embodiment of the invention.

In the embodiment of this second enrollment phase described here, it is assumed that the application ID_W provides (step R30) to the server SRV a profile P_{U} of the user U including the application key K_{W}, their private key K^{SEC}_{U} obtained from the digital identity provider FIN and a personal service code PIN^{S}_{U}.

In another embodiment, upon receipt of the profile P_{U} of the user U, the server SRV generates the key pair (private key K^{SEC}_{U}, public key private key K^{PUB}_{U}) from the HSM and sends back the generated public key to the digital identity provider FIN and to the application ID_W. The key pair of the user U then being stored encrypted locally to the server SRV, the server SRV knowing at any time how to restore the key context and the profile P_{U} of the user U to process any future signature request from the user via their application ID_W. In this other embodiment, the generation of the key pair within the HSM allows accessing other more advanced cryptography services, known to those skilled in the art and particularly the possibility for a private key (K^{SEC}_{U}) already allocated to the user U to generate different public keys for multiple digital identity providers FINK. In the embodiment described here, this personal service code PIN^{S}_{U} is different from the personal code PIN^{C}_{U} of the SIM card SIM_{U}. The personal service code used subsequently during the secure data provision method, always noted PIN^{S}_{U}, is either this personal service code provided by the user or a service code derived from this personal service code. This personal service code represents a phase of conscious acceptance of the transaction, via an active approach, by the user.

In the embodiment described here, this personal service code PIN^{S}_{U} can be stored, directly or in a diversified manner according to the state of the art, in the secure element SE of the mobile terminal TRM_{U} or directly in the memory associated with the application ID_W as illustrated in FIG. 2.

In the embodiment described here, the server SRV stores the profile P_{U} of the user U in a database BD as illustrated in FIG. 4.

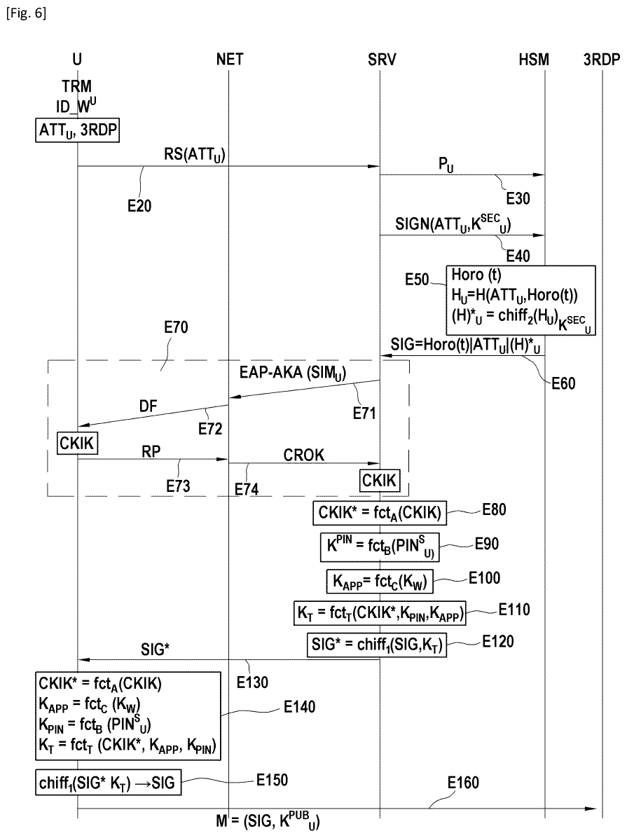

FIG. 6 represents, in the form of a flowchart, the main steps of the signed data provision method and of the data signature method implemented when the user U wishes to share an attribute ATT_{U}, for example their address ADD, with a third party 3RDP.

During a step E10, the user U uses an HMI interface of their application ID_W to select an attribute ATT_{U} and a third party 3RDP to whom they wish to provide this attribute.

In accordance with the invention, the attribute ATT_{U} must be signed with the private key K^{SEC}_{U} allocated to the user U by the identity provider FIN and kept secret by the HSM component of the server SRV.

During a step E20, the application ID_W of the user U sends a signature request RS to the server SRV to ask it to sign this attribute ATT_{U}.

In one particular embodiment of step E20, the attribute ATT to be signed is not sent “in clear” to the server SRV, but emitted encrypted with a specific key of the HSM component and unknown to the server SRV. The server SRV then transfers this encrypted attribute to be signed to the HSM which can then retrieve the clear value of the attribute.

During a step E30, the server SRV downloads into the HSM component the profile P_{U} of the user U stored in the database BD. This profile P_{U} in particular includes the private key K^{SEC}_{U} allocated to the user U by the identity provider.

During a step E40, the server SRV asks the HSM component to sign the attribute ATT_{U} of the user U with the private key K^{SEC}_{U} allocated to the user U.

During a step E50, the HSM component determines a timestamp data Horo(t) of the current instant t, calculates, by using the hash function H, a hash H_{U} of the concatenated set (attribute ATT_{U}, timestamp Horo(t)) and encrypts this hash H_{U} with the private key K^{SEC}_{U} allocated to the user U by using the second encryption function chiff₂.

(H_{U})* denotes the result of this encryption of the hash H_{U}.

During a step E60, the HSM component responds to the signature request (step E40) by sending back to the server SRV a signature SIG including the timestamp data Horo(t), the attribute ATT_{U} and the result (H_{U})* of the encryption of the hash H_{U}.

During a step E70, the server SRV forces re-authentication of the terminal TRM_{U} of the user U at the home mobile network NET.

In one particular embodiment, this forced re-authentication step E70 includes the following steps E71 to E74.

During a step E71, the server SRV sends to the mobile network NET a request from the EAP-AKA family, or one of its extensions, to re-authenticate the SIM card SIM_{U} of the user U.

It is recalled that the EAP-AKA (Authentication and Key Agreement) method is an EAP method for the clients of the 3^{rd} generation mobile telephone networks (UMTS and CDMA2000). It is described in RFC 4187, and multiple variants exist depending on the generation of the targeted mobile network and the capabilities of the terminals. As a reminder, the protocol family called EAP protocol is a network communication protocol incorporating multiple authentication methods, which can be used on point-to-point links (RFC 22841), the wired networks and the wireless networks (RFC 37482, RFC 52473) such as the Wi-Fi networks.

For this purpose, the home network NET sends, during a step E72, a challenge DF to the terminal TRM_{U}, to which the SIM card SIM_{U} responds with a response RP (step E73) after having locally generated a key {C_{K}, I_{K}} known to those skilled in the art. In the remainder of the description, “re-authentication key CKIK” will refer to a key {C_{K}, I_{K}} or one of its derivations, or any secret element intrinsic to the EAP-AKA exchange and shared at least between the SIM card SIM_{U}, the home network NET, and potentially the terminal TRM_{U}.

During a step E74, the mobile network NET verifies the response RP and, if the SIM card SIM_{U} is re-authenticated, it sends back to the server SRV a response CROK and the re-authentication key CKIK.

One result of this re-authentication procedure E70 is to make the re-authentication key CKIK, available after the re-authentication procedure at the SIM card SIM_{U} of the terminal, available to the server SRV.

In the embodiment described here, during a step E80, the server SRV calculates a derived key CKIK* from the re-authentication key CKIK by using the first key derivation function fct_{A} shared with the application ID_W of the terminal TRM_{U}.

In the embodiment described here, during a step E90, the server SRV calculates a key K_{PIN} derived from the personal service code PIN^{S}_{U} of the user U obtained during the enrollment phase (step R30) by using the second key derivation function fct_{B} shared with the application ID_W of the terminal TRM_{U}.

In the embodiment described here, during a step E100, the server SRV calculates a key K_{APP} derived from the application key K_{W} obtained during the enrollment phase (step R30) by using the third key derivation function fct_{C} shared with the application ID_W of the terminal TRM_{U}.

In the embodiment described here, during a step E110, the server SRV calculates a transport key K_{T} from:
the key CKIK* derived from the re-authentication key CKIK in step E80;
the key K_{PIN} derived from the personal service code PIN^{S}_{U} in step E90; and
the key K_{APP} derived from the application key K_{W} in step E100;
by using the fourth key derivation function fct_{T} shared with the application ID_W of the terminal TRM_{U}.

In a first variant, during step E110, the server SRV calculates the transport key K_{T} from:
the key CKIK* derived from the re-authentication key CKIK in step E80; and
the key K_{PIN} derived from the personal service code PIN^{S}_{U} in step E90; and
by using the fourth key derivation function fct_{T} shared with the application ID_W of the terminal TRM_{U}.

In a second variant, during step E110, the server SRV calculates the transport key K_{T} from:
the key CKIK* derived from the re-authentication key CKIK in step E80; and
the key K_{APP} derived from the application key K_{W} in step E100;
by using the fourth key derivation function fct_{T} shared with the application ID_W of the terminal TRM_{U}.

During a step E120, the server SRV encrypts the signature SIG received from the HSM component in step E60 with the first encryption function chiff₁ by using the transport key K_{T}.

The server SRV sends this encrypted signature SIG* to the application ID_W during a step E130 in response to a signature request RS received in step E20.

During a step E140, the application ID_W:
obtains the CKIK stored in the SIM card SIM_{U} at the end of the forced re-authentication step E70 and retrieves the key CKIK* by using the first derivation function fct_{A};
obtains the application key K_{W} stored for example in the secure element SE of the terminal TRM_{U} and retrieves the key K_{APP} by using the third derivation function fct_{C};
asks the user to enter their personal service code PIN^{S}_{U} and retrieves the key K_{PIN} by using the second derivation function fct_{B}; and
calculates the transport key K_{T} from CKIK*, K_{PIN} and K_{APP} by using the fourth key derivation function fct_{T} shared with the server SRV.

During a step E150, the application ID_W uses the first encryption function chiff₁ to decrypt the encrypted signature SIG* received in step E130 by using the transport key K_{T} and obtains the signature SIG including the timestamp data horo(t), the attribute ATT_{U} of the user and the result (H_{U})* of the encryption of the hash H of this information with the private key K^{SEC}_{U} allocated to the user U. As a variant, this decryption could be performed by a decryption module of the terminal TRM_{U} independent of the application ID_W.

In the embodiment described here, during a step E160, the application ID_W sends to the third party 3RDP a message M including the signature SIG and a complement C comprising the public key K^{PUB}_{U} allocated to the user U by the identity provider FIN. It is recalled that the signature SIG includes, in this example, the timestamp Horo(t), the attribute ATT_{U}, a hash (H_{U})* of these data encrypted with the private key K^{SEC}_{U} allocated to the user U by the identity provider FIN and kept secret by the HSM component.

In this embodiment, the third party 3RDP is thus autonomous in verifying the signature SIG thanks to the receipt of the user's public key and its knowledge of the hash function H and of the second encryption function chiff₂.

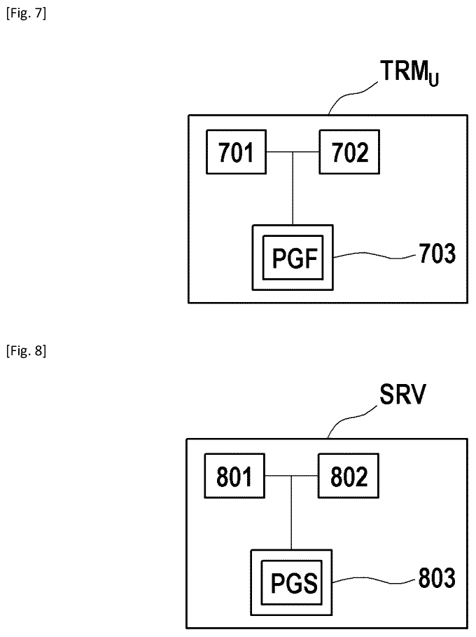

FIG. 7 represents the hardware architecture of a terminal TRM_{U} in accordance with one particular embodiment of the invention. This terminal includes:
a processing unit or processor 701 or CPU, intended to load instructions into memory, to execute them, to perform operations;
a set of memories, including a volatile memory 702 or RAM, used to execute code instructions, store variables, etc., and a storage memory 703 of the EEPROM type. Particularly, the storage memory 703 is arranged to store a software module PGF for providing signed data which comprises code instructions for implementing the steps of the signed data provision method as described previously.

FIG. 8 represents the hardware architecture of a server SRV in accordance with one particular embodiment of the invention. This server includes:
a processing unit or processor 801 or CPU, intended to load instructions into memory, to execute them, to perform operations;
a set of memories, including a volatile memory 802 or RAM, used to execute code instructions, store variables, etc., and a storage memory 803 of the EEPROM type. Particularly, the storage memory 803 is arranged to store a signature software module PGS which comprises code instructions for implementing the steps of the signature method as described above.

In the embodiment described above, the signed data are attributes related to the user's identity.

However, data of any type can be signed by the invention.

Particularly, the signed data can be a combination of attributes.

Furthermore, instead of providing an attribute as such, the invention can be used to provide a cryptographic derivation of this attribute, for example by using an algorithm with a zero proof of knowledge.

1. A data signature method implemented by a server and including:
receiving a signature request for at least one data sent by a terminal via a network;
obtaining, by a secure element of the server, a signature of said at least one data by using a private key associated with the terminal, said signature being intended to be verified by a third party knowing a public key associated with said private key;
obtaining a re-authentication key for the terminal from the network;
encrypting the signature with an encryption function shared with the terminal and by using a transport key calculated from the re-authentication key and at least one other authentication key for the terminal or for a user of the terminal; and
sending the encrypted signature to the terminal.

2. A signed data provision method implemented by a terminal and including:
sending a signature request for at least one data to a server via a network;
obtaining a re-authentication key for the terminal from the network;
receiving an encrypted signature;
decrypting the encrypted signature with an encryption function shared with the server and by using a transport key calculated from the re-authentication key and at least one other authentication key for the terminal or for a user of the terminal to obtain a signature of said data calculated by using a private key associated with the terminal; and
sending the signature to a third party device configured to verify validity of the signature with a public key associated with said private key.

3. The method according to claim 1, wherein said signature includes:
a timestamp data of an instant of calculation of said signature;
a hash of a concatenation of said data to be signed and of said timestamp data; and
a data*) obtained by encrypting said hash with another encryption function by using said private key, a function used to calculate said hash and the other encryption function being shared between said server and said third party device.

4. The method according to claim 1, characterized in that wherein said re-authentication key is obtained by a method for re-authenticating a SIM card of the terminal triggered by said server.

5. The method according to claim 1, wherein the server triggers a re-authentication of the terminal from the network to regenerate the re-authentication key after sending the encrypted signature to the terminal.

6. The method according to claim 4, wherein said re-authentication method is an Extensible Authentication Protocol-Authentication and Key Agreement (EAP-AKA) type-method.

7. The method according to claim 1, wherein said transport key is calculated from a key calculated by using a derivation function shared between the terminal and the server and a personal service code of a user of the terminal.

8. The method according to claim 1, wherein said transport key is calculated from a key calculated by using a derivation function shared between the terminal and the server and a key from an application of a secure electronic wallet of the terminal.

9. A data signature server including:
a secure element configured to obtain a signature of at least one data by using a private key associated with a terminal;
at least one processor; and
at least one non-transitory computer readable medium comprising instructions stored thereon which when executed by the at least one processor configure the data signature server to:
receive a signature request for the at least one data sent by the terminal via a network;
obtain a re-authentication key for the terminal from the network;
encrypt the signature with an encryption function shared with the terminal and by using a transport key calculated from the re-authentication key and at least one other authentication key for the terminal or for a user of the terminal; and
send the encrypted signature to the terminal.

10. A terminal including:
at least one processor; and
at least one non-transitory computer readable medium comprising instructions stored thereon which when executed by the at least one processor configure the terminal to:
send a signature request for at least one data to a server via a network;
obtain a re-authentication key for the terminal from the network;
receive an encrypted signature;
decrypt the encrypted signature with an encryption function shared with the terminal and by using a transport key calculated from the re-authentication key and at least one other authentication key for the terminal or for a user of the terminal to obtain a signature of said data calculated by using a private key associated with the terminal; and
send the signature to a third party device configured to verify validity of the signature with a public key associated with said private key.

11. (canceled)

12. A non-transitory computer readable medium having stored thereon instructions which, when executed by a computer of the server, cause the program to implement the method of claim 1.

13. A non-transitory computer readable medium having stored thereon instructions which, when executed by a computer of a terminal, cause the program to implement the method of claim 2.

14. (canceled)

15. The method according to claim 2, wherein said signature includes:
a timestamp data of an instant of calculation of said signature;
a hash of a concatenation of said data to be signed and of said timestamp data; and
data obtained by encrypting said hash with another encryption function by using said private key, a function used to calculate said hash and the other encryption function being shared between said server and said third party device.

16. The method according to claim 2, wherein said re-authentication key is obtained by a method for re-authenticating a SIM card of the terminal triggered by said server.

17. The method according to claim 2, wherein that said transport key is calculated from a key calculated by using a derivation function shared between the terminal and the server and a personal service code of a user of the terminal.

18. The method according to claim 2, wherein said transport key is calculated from a key calculated by using a derivation function shared between the terminal and the server and a key from an application of a secure electronic wallet of the terminal.
